(19) United States
(12) Patent Application Publication
(10) Pub. No.: US 2025/0130060 A1
(43) Pub. Date: Apr. 24, 2025

(54) SYSTEM AND METHOD FOR QUESTION ANSWERING, INFORMATION RETRIEVAL, AND LOCATION DISCOVERY

(71) Applicant: THE ADJACENT POSSIBLE OY, Helsinki (FI)

(72) Inventors: Nicolò SGOBBA, Helsinki (FI); William CARBONE, Helsinki (FI); Vlad Stefan LICHTENTHAL, Helsinki (FI)

(21) Appl. No.: 18/722,081

(22) PCT Filed: Nov. 15, 2022
(86) PCT No.: PCT/FI2022/050747

§ 371 Date: Jun. 20, 2024

(30) Foreign Application Priority Data
Dec. 22, 2021 (FI) 20216327

(51) Int. Cl. G01C 21/36; G06F 16/9537; G06F 40/279

(52) U.S. Cl. CPC G01C 21/3679; G06F 16/9537; G06F 40/279

(57) ABSTRACT

An information system for question answering, information retrieval, and location discovery. The information system is configured to receive an input inquiry from an input user device, generate input inquiry metadata from the input inquiry, determine an input location of the input user device, and determine one or more points of interest within a first predetermined distance from the input location. The system is further configured to detect output user devices within a predetermined output distance from the one or more points of interest, share the input inquiry with the detected output user devices, and receive one or more responses from the output user devices within the predetermined output distance from the one or more points of interest.

### FIELD OF THE INVENTION

The present invention relates to an information system for question answering, information retrieval, and location discovery and more particularly to an information system according to the preamble of claim 1. The present invention further relates to a method for question answering, information retrieval, and location discovery and more particularly to a method according to the preamble of claim 18. The present invention also relates to a computer program product and more particularly to a computer program product according to preamble of claim 20 or 21.

### BACKGROUND OF THE INVENTION

At present, online or web-based applications or services, or search engines, and the like, are capable of retrieving information about any possible topic in milliseconds. Given any search query, no matter how complex, if the information is accessible online and is available, the above-mentioned systems can retrieve and return the information of interest. However, even though there are myriads of platforms, channels, and digital venues such as blogs, forums, social media, and the like, where one could ask for even very specific information, whenever this is not directly available online, at times the question could potentially never get to the precise user or system that can certainly and accurately respond. This is true even if topic-based channels or specialized platforms in the topic relevant to the inquiry are used to convey the inquiry. This is partly because offline available information may never be available online as these pertain to tacit knowledge, or are “hear and say” information, or are time-bounded requests that are not informative anymore after a certain small amount of time, and cannot or may not become generally available online.

### BRIEF DESCRIPTION OF THE INVENTION

An object of the present invention is to provide an information system, such that the prior art disadvantages are solved or at least alleviated.

The objects of the invention are achieved by an information system that is characterized by what is stated in the independent claim 1. The objects of the invention are further achieved by a method that is characterized by what is stated in the independent claim 18. The objects of the invention are also achieved by a method that is characterized by what is stated in the independent claim 18. The objects of the invention are also achieved by a computer program product that is characterized by what is stated in the independent claim 20 or 21.

The preferred embodiments of the invention are disclosed in the dependent claims.

The invention is based on the idea of providing an information system and method for question answering, information retrieval, and location discovery. The information system comprises one or more processors and a memory storing instructions for execution by one or more processors. The information system is configured to maintain an information location map comprising an area map.

In some embodiments, the area map is configured as a geographical map representing geographical areas in the real world or physical environment.

In some other embodiments, the area map is configured as a virtual environment map, or an augmented environment map representing extra layers of information in the real world or physical environment, or any combination of these.

In some other embodiments, and by extension, the area map is configured in a way that can locate and/or identify any virtual object in the real world, or real object in the virtual world that can be located and/or identified on a geographical and/or a virtual map, and within the scope of reality or mixed/extended reality or virtuality, and/or any combination of these.

The information system is further configured to carry out process A) comprising:
receiving an input inquiry from an input user device, the input inquiry comprising input text corpus,
generating, with an input context generator, input inquiry metadata by analysing the input text corpus, the input inquiry metadata comprising one or more input text objects generated from the input text corpus of the input inquiry,
determining, with the input context generator, an input location of the input user device on the information location map, and
determining, with a map locator, one or more points of interest on the information location map within a first predetermined distance from the input location based on the one or more input text objects of the input inquiry metadata and the information location map.

Accordingly, the information system is configured to detect one or more points of interest in the information location map close to the input user device, or an input user based on the input inquiry and context of the input inquiry.

The information system is further configured to carry out process B) comprising:
detecting, with an output context generator, output user devices within a predetermined output distance from the one or more points of interest,
sharing the input inquiry with the detected output user devices within the predetermined output distance from the one or more points of interest,
receiving one or more responses from the output user devices within the predetermined output distance from the one or more points of interest, and
generating a response notification based on the one or more responses received from the output user devices and providing the response notification to the input user device.

Accordingly, the information system of the present invention is configured to detect output user devices or output users that are close to the determined one or more points of interest, and to share the input inquiry to these user devices. Therefore, the responses may be collected from users or user devices that are close to the location of the one or more points of interest. This provides efficient access to information that may not be online, for example on the Internet, but that can only be accessed by users near the location of the information.

In some embodiments, the first predetermined distance is 1 km, or 5 km, or 10 km or 20 km.

In some embodiments, the predetermined output distance is 1 km, or 5 km, or 10 km or 20 km.

In some embodiments, the input context generator comprises an input location detector configured to determine the input location of the input user device by one or more of the following: determine input user device GPS location, determine input user device IP address location, determine input user device cellular network location, and determine the location of the input user device by deriving the location from the input inquiry or the input inquiry metadata.

In some other embodiments, the area map of the information location map is a virtual or an augmented environment map, and the input location detector is configured to determine the input location based on the location identifier associated with the input user or input user device.

In some embodiments, the map locator is configured to associate the input user device to the input location on the information location map.

When the input user device or input user is associated with the input location on the information location map, the one or more points of interest within the first predetermined distance from the input location may be determined on the information location map.

In some embodiments, the input context generator comprises an input context detector configured to generate primary input inquiry metadata. The primary input inquiry metadata comprising one or more primary input text objects generated from the input text corpus of the input inquiry, the input context detector is configured to carry out one or more of the following:
detect the language of the input text corpus,
divide the input text corpus to n-grams, the one or more primary input text objects comprising the n-grams, and
identify keywords in the input text corpus, the one or more primary input text objects comprising the keywords.

The input context detector analyses the input text corpus and generates n-grams from the input text corpus and further identifies keywords. The input context detector thus generates primary input text objects which comprise the n-grams and keywords. The keywords may comprise for example product names, location-related words, object names, action-related words, or the like. Accordingly, the input context detector is configured to identify information included in the input inquiry and generates the primary input text objects.

In some embodiments, the input context generator comprises an input context enhancer configured to generate secondary input inquiry metadata. The secondary input inquiry metadata comprising one or more secondary input text objects generated from the one or more primary input text objects of the primary inquiry metadata, the input context enhancer is configured to carry out one or more of the following:
determine synonyms for the n-grams in the primary input inquiry metadata, and
determine synonyms for the keywords in the primary input inquiry metadata.

The input context enhancer is configured to expand the information included in the input inquiry. The input context enhancer thus generates secondary input text objects from the primary input metadata and primary input text objects. Accordingly, the input context enhancer is configured to determine and generate synonyms for the input text objects, the n-grams, and the keywords.

The primary input metadata and the secondary input metadata enhance the identification and localization of the one or more points of interest on the information location map.

In some embodiments, the input inquiry comprises image data or video data, and the information system is upon receiving the input inquiry configured to generate an image text description from the image data or video data and incorporate the image text description generated from the image data or video data to the input text corpus.

In some alternative embodiments, the input inquiry comprises image data or video data, and the information system is upon receiving the input inquiry configured to carry out optical character recognition to the image data or video data, generate an image text description of the image data or video data based on the optical character recognition, and incorporate the image text description generated from the image data or video data to the input text corpus.

In some further alternative embodiments, the input inquiry comprises image data or video data, and the information system is upon receiving the input inquiry configured to generate an image text description from the image data or video data and incorporate the image text description generated from the image data or video data to the input text corpus, and carry out optical character recognition to the image data or video data, generate an image text description of the image data or video data based on the optical character recognition, and incorporate the image text description generated from the image data or video data to the input text corpus.

Therefore, the information system is configured to convert the image data and/or video data into an image text description defining the content of the image data and/or video data. The information system is further configured to incorporate the image text description into the input text corpus. Thus, the image text description is utilized in generating the input inquiry metadata, primary input metadata, and secondary input metadata.

In some embodiments, the input inquiry comprises audio data, and the information system is upon receiving the input inquiry configured to generate an audio text description from the audio data and incorporate the audio text description generated from the audio data to the input text corpus.

In some other embodiments, the input inquiry comprises audio data, and the information system is upon receiving the input inquiry configured to carry out speech recognition to the audio data and generate an audio text description based on the speech recognition and incorporate the audio text description to the input text corpus.

In some further embodiments, the input inquiry comprises audio data, and the information system is upon receiving the input inquiry configured to generate an audio text description from the audio data and incorporate the audio text description generated from the audio data to the input text corpus, and carry out speech recognition to the audio data and generate an audio text description based on the speech recognition and incorporate the audio text description to the input text corpus.

Therefore, the information system is configured to convert the audio data into an audio text description defining the content of the audio data. The information system is further configured to incorporate the audio text description into the input text corpus. Thus, the audio text description is utilized in generating the input inquiry metadata, primary input metadata, and secondary input metadata.

In some embodiments, the information location map comprises the area map and information objects associated with area locations on the information location map. The map locator is configured to determine the one or more points of interest compare the one or more input text objects of the input inquiry metadata with the information objects of the information location map, and determine the one or more points of interest on the information location map based on the comparing, the one or more points of interest being associated to an information object on the information location map matching with an input text object of the input inquiry metadata.

In some other embodiments, the information location map comprises the area map and information objects associated with area locations on the information location map. The map locator is configured to compare the one or more primary input text objects of the primary input inquiry metadata with the information objects of the information location map, compare the one or more secondary input text objects of the secondary input inquiry metadata with the information objects of the information location map, and determine the one or more points of interest based on the comparing, the one or more points of interest being associated to an information object matching with a primary input text object in the primary input inquiry metadata, or with a secondary input text object in the secondary input inquiry metadata, or with a primary input text object in the primary input inquiry metadata and with a secondary input text object in the secondary input inquiry metadata.

Accordingly, the information objects are included, embedded, or associated with the information location map. Therefore, the information location map comprises the information objects.

The information objects can be buildings, stores, roads, addresses, districts, attractions, historical/recognizable points of interest like fountains or statues, industrial sites, transport or traffic stations, physical or virtual entities, or the like, in geographical locations or within virtual locations.

In some embodiments, the information system comprises a known places database, the known places database maintaining information objects, the information objects having associated area location information. The map locator is configured to determine the one or more points of interest on the information location map by:
comparing the one or more input text objects of the input inquiry metadata with the information objects of the known places database,
determining a matching information object in the known places database based on comparing the one or more input text objects of the input inquiry metadata with the information objects of the known places database, and
determining the one or more points of interest on the information location map based on the location information associated with the matching information object.

In an alternative embodiment, the information system comprises a known places database, the known places database maintaining information objects, the information objects having associated area location information. The map locator is configured to determine the one or more points of interest on the information location map by:
comparing the one or more primary input text objects of the primary input inquiry metadata with the information objects of the known places database,
comparing the one or more secondary input text objects of the secondary input inquiry metadata with the information objects of the known places database,
determining a matching information object in the known places database based on comparing the one or more primary input text objects of the primary input inquiry metadata and the one or more secondary input text objects of the secondary input inquiry metadata with the information objects of the known places database, and
determining the output location on the information location map based on the location information associated with the matching information object.

Accordingly, the information system is configured to match the input inquiry with an information object in the known places database and then determine the one or more points of interest on the information location based on the matching associate. In this embodiment, the information location map does not comprise the information objects, but the known places database comprises the information objects. The known places database may be an internal database in the system or an external database. Accordingly, the information system may also utilize several different internal, external, or third-party databases, or any combination of these, comprising information objects with location information from the physical, augmented, mixed, or virtual environment, or any combination of these. Thus, each of these external databases may be a known places database. Therefore, by extension, an information object can be any virtual object in the real world, or real object in the virtual world, that can be located and/or identified on a geographical and/or a virtual map, and within the scope of reality or mixed/extended reality or virtuality, and/or any combination of these.

In some embodiments, the output context generator comprises an output location detector configured to determine the location of the output user devices by one or more of the following: determine output user device GPS location, determine output user device IP address location, determine output user device cellular network location, and determine the location of the output user device by deriving the location from the received response.

In some other embodiments, the area map of the information location map is the virtual or the augmented environment map, and the output location detector is configured to determine the output location based on the location identifier associated with the output users or output user devices.

In some embodiments, the map locator is configured to associate the output user devices to the output location on the information location map.

In some embodiments, the one or more responses comprising output text corpus, and the output context generator is configured to generate output response metadata for each of the received one or more responses by analysing output text corpus of each of the received one or more responses, the output response metadata comprising one or more output text objects generated from the output text corpus of the one or more responses, respectively.

In some embodiments, the output context generator comprises an output context detector configured to generate primary output response metadata. The primary output response metadata comprising one or more primary output text objects generated from the output text corpus of the output response, the output context detector is configured to carry out one or more of the following:
detect the language of the output text corpus,
divide the output text corpus to n-grams, the one or more primary output text objects comprising the n-grams, and
identify keywords in the output text corpus, the one or more primary output text objects comprising the keywords.

The output context detector analyses the output text corpus and generates n-grams from the output text corpus and further identifies keywords. The output context detector thus generates primary output text objects which comprise the n-grams and keywords. The keywords may comprise for example product names, location-related words, object names, action-related words, or the like. Accordingly, the output context detector is configured to identify information included in the output response and generates the primary output text objects.

In some embodiments, the output context generator comprises an output context enhancer configured to generate secondary output response metadata. The secondary output response metadata comprising one or more secondary output text objects generated from the one or more primary output text objects of the primary output response metadata, the input context enhancer is configured to carry out one or more of the following:
determine synonyms for the n-grams in the primary output response metadata, and
determine synonyms for the keywords in the primary output response metadata.

The output context enhancer is configured to expand the information included in the output response. The output context enhancer thus generates secondary output text objects from the primary output metadata and primary output text objects. Accordingly, the output context enhancer is configured to determine and generate synonyms for the output text objects, the n-grams, and the keywords.

The primary output metadata and the secondary output metadata enhance analysing the responses in relation to the input inquiry.

In some embodiments, the output response comprises image data or video data, and the information system is upon receiving the output response to generate an image text description from the image data or video data and incorporate the image text description generated from the image data or video data to the output text corpus.

In some alternative embodiments, the output response comprises image data or video data, and the information system is upon receiving the output response configured to carry out optical character recognition to the image data or video data, generate an image text description of the image data or video data based on the optical character recognition, and incorporate the image text description generated from the image data or video data to the output text corpus.

In some further alternative embodiments, the output response comprises image data or video data, and the information system is upon receiving the output response configured to generate an image text description from the image data or video data and incorporate the image text description generated from the image data or video data to the output text corpus, and carry out optical character recognition to the image data or video data, generate an image text description of the image data or video data based on the optical character recognition, and incorporate the image text description generated from the image data or video data to the output text corpus.

Therefore, the information system is configured to convert the image data and/or video data into an image text description defining the content of the image data and/or video data. The information system is further configured to incorporate the image text description into the output text corpus. Thus, the image text description is utilized in generating the output response metadata, primary output metadata, and secondary output metadata.

In some embodiments, the output response comprises audio data, and the information system is upon receiving the output response configured to generate an audio text description from the audio data and incorporate the audio text description generated from the audio data to the output text corpus.

In some other embodiments, the output response comprises audio data, and the information system is upon receiving the output response configured to carry out speech recognition to the audio data and generate an audio text description based on the speech recognition and incorporate the audio text description to the output text corpus.

In some further embodiments, the output response comprises audio data, and the information system is upon receiving the output response configured to generate an audio text description from the audio data and incorporate the audio text description generated from the audio data to the output text corpus, and carry out speech recognition to the audio data and generate an audio text description based on the speech recognition and incorporate the audio text description to the output text corpus.

Therefore, the information system is configured to convert the audio data into an audio text description defining the content of the audio data. The information system is further configured to incorporate the audio text description into the output text corpus. Thus, the audio text description is utilized in generating the output response metadata, primary output metadata, and secondary output metadata.

In some embodiments, the information system comprises a response collector, the response collector being configured to:
maintain a pre-determined response score threshold,
receive one or more candidate responses from the output user devices,
determine a response score for each of one or more candidate responses by comparing the output text corpus of each of the one or more candidate responses with the input text corpus of the input inquiry, or the output text corpus and output response metadata of each of the one or more candidate responses with the input text corpus and input inquiry metadata of the input inquiry,
compare the response score of each of the candidate responses with the pre-determined response score threshold, and based on the comparing the response collector is configured to
   discard the candidate response if the response score of the candidate response is below the pre-determined response score threshold, or
   store the candidate response as a qualified response if the response score of the candidate response is above the pre-determined response score threshold.

Accordingly, the information system and the response collector are configured to analyse the received candidate responses by comparing them to the input inquiry to determine the coherence of each of the received candidate responses to the input inquiry. Therefore, only these responses are stored which are above the pre-determined response score threshold and thus coherent with the input inquiry. Thus, only responses that include relevant information relating to the input inquiry are stored.

In some embodiments, the information location map comprises the area map and information objects associated with area locations on the information location map, the map locator being configured to determine a response location on the information location map by:
comparing the one or more output text objects of the output response metadata with the information objects of the information location map, and
determining the response location on the information location map based on the comparing, the response location being associated to an information object on the information location map matching with an output text object of the input inquiry metadata.

Accordingly, the map locator is configured to determine the response location for each of the output responses on the information location map. Therefore, the information system provides a location relating to the output response in addition to the response content.

In some embodiments, the map locator is configured to determine a response location on the information location map by:
comparing the one or more output text objects of the output response inquiry metadata with the information objects of the known places database,
determining a matching information object in the known places database based on comparing the one or more output text objects of the output response metadata with the information objects of the known places database, and
determining the one or more points of interest on the information location map based on the location information associated with the matching information object.

Accordingly, the map locator is configured to determine the response location for each of the output responses on the information location map by utilizing the known places database. Therefore, the information system provides a location relating to the output response in addition to the response content.

In some embodiments, the information system comprises the response collector, the response collector being configured to:
maintaining a first pre-determined response number threshold,
calculating a number of received responses or qualified responses, or keep tally of received responses or qualified responses, and
   if the number of received responses or qualified responses is above the first pre-determined response number threshold, generate the response notification based on the received responses or qualified responses and provide the response notification to the input user device, or
   if the number of received responses or qualified responses is below the first pre-determined response number threshold, the information system is configured to:
      determine, with the map locator, subsequent one or more points of interest on the information location map within the predetermined distance from the previous one or more points of interest based on the one or more input text objects of the input inquiry metadata and the information location map, and
      carry out process B)
      detect, with the output context generator output user devices within the predetermined output distance from the subsequent one or more points of interest,
      share the input inquiry with the detected output user devices within the predetermined output distance from the subsequent one or more points of interest,
      receive one or more responses from the output user devices within the predetermined output distance from the subsequent one or more points of interest, and
      generating the response notification based on the one or more responses received from the output user devices and providing the response notification to the input user device.

Accordingly, if the number of received or qualified responses is below the response number threshold, the information system and the response collector are configured to determine new subsequent one or more points of interest within the predetermined distance from the previous one or more points of interest. The subsequent one or more points of interest are then used as a starting point, and output users are detected within the predetermined output distance from the subsequent one or more points of interest.

In some embodiments, the information system comprises the response collector, the response collector being configured to:
detect a cluster of response locations on the information map by comparing the response locations of the received responses or qualified responses, and
if the cluster of response locations is detected on the information location map, generating the response notification based on the responses associated with the cluster and providing the response notification to the input user device, or
if a cluster of response locations is not detected on the information location map, the information system is configured to:
   determine, with the map locator, subsequent one or more points of interest on the information location map within the predetermined distance from the previous one or more points of interest based on the one or more input text objects of the input inquiry metadata and the information location map, and
   carry out process B)
   detect, with the output context generator, output user devices within the predetermined output distance from the one or more subsequent points of interest,
   share the input inquiry with the detected output user devices within the predetermined output distance from the one or more subsequent points of interest,
   receive one or more responses from the output user devices within the predetermined output distance from the one or more subsequent points of interest, and
   generate a response notification based on the one or more responses received from the output user devices, and provide the response notification to the input user device.

Accordingly, the information system is configured to only utilize responses that form a cluster on the information location map. The cluster means that the response locations of the responses forming the cluster are close to each other on the information location map or associated with the same information object and/or the same information location on the information location map. This ensures a higher accuracy of the responses.

In some embodiments, the information system comprises a response aggregator, the response aggregator being configured to:
aggregate the one or more received responses into a single response,
determine an aggregated response location for the single response based on the response locations of the received responses, and
associate the aggregated response location with the single response.

In some alternative embodiments, the information system comprises a response aggregator, the response aggregator being configured to:
aggregate the qualified responses into a single response,
determine an aggregated response location for the single response based on the response locations of the qualified responses,
associate the aggregated response location with the single response.

In some further embodiments, the information system comprises a response aggregator, the response aggregator being configured to:
aggregate the one or more responses associated with the cluster into a single response,
determine an aggregated response location for the single response based on the response locations of the responses associated with the cluster, and
associate the aggregated response location with the single response.

Aggregating several responses into one response having one response location enables increasing the quality of the response provided to the input user and also enables providing more efficient operation as only one response is to be generated.

The present invention also provides a method for question answering, information retrieval, and location discovery to be implemented with a system according to the claims.

The present invention is further based on an idea of providing a method for question answering, information retrieval, and location discovery. The method is carried out with an information system comprising one or more processors and a memory storing instructions for execution by the one or more processors, characterized in that the method comprises:
providing an information location map, the information location map comprising an area map;
carrying out process A) comprising
   receiving an input inquiry from an input user device, the input inquiry comprising input text corpus,
   generating, with an input context generator, input inquiry metadata by analysing the input text corpus, the input inquiry metadata comprising one or more input text objects generated from the input text corpus of the input inquiry,
   determining, with the input context generator, an input location of the input user device on the information location map,
   determining, with a map locator, one or more points of interest on the information location map within a first predetermined distance from the input location of the input user device based on the one or more input text objects of the input inquiry metadata and the information location map; and
carrying out process B)
   detecting, with an output context generator output user devices within a predetermined output distance from the one or more points of interest on the information location map,
   sharing the input inquiry with the detected output user devices within the predetermined output distance from the one or more points of interest,
   receiving one or more responses from the detected output user devices within the predetermined output distance from the one or more points of interest, and
   generating a response notification based on the one or more responses received from the detected output user devices and provide the response notification to the input user device.

In some embodiments, the method is carried out with an information system as disclosed above.

The present invention further provides a computer program product configured to carry out the method according to the present invention.

The present invention also provides a computer program product comprising instructions for operating the information system according to the claims.

An advantage of the invention is that it enables reaching information that is available offline. The information is accurate as the responses are received from output users close to the location of the one or more points of interest based on the question or input inquiry. Therefore, the relevance of the responses in relation to the input inquiry is high and accurate. Further, the information system of the present invention enables enhancing the content of responses by detecting the clusters and/or by aggregating several responses into one response.

### BRIEF DESCRIPTION OF THE DRAWINGS

The invention is described in detail by means of specific embodiments with reference to the enclosed drawings, in which

FIGS. 1 and 2 schematically show a system according to one of the embodiments of the present invention;

FIGS. 3 to 14 schematically show a method and operation of a system according to one embodiment of the present invention; and

FIGS. 15 to 22 schematically show a visual representation of the operation of a system according to two embodiments of the present invention.

### DETAILED DESCRIPTION OF THE INVENTION

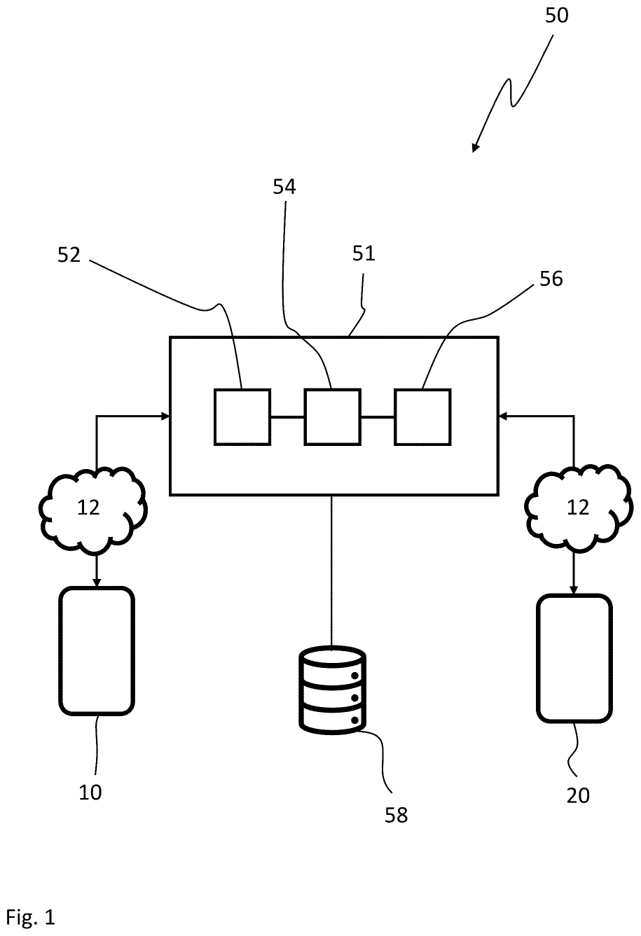

FIG. 1 shows schematically an information system 50 according to the present invention. In the information system 50, a user may connect to an information server system 51 by using user devices 10, 20 via a communications network 12. It should be noted that FIG. 1 presents a simplified version of the information system 50 and that in other embodiments, an unlimited number of users may be able to connect to the information server system 51 via the communications network 12.

The communications network 12 may comprise one or more wireless networks, wherein a wireless network may be based on any mobile system, such as GSM, GPRS, LTE, 4G, 5G, and beyond, and a wireless local area network, such as Wi-Fi. Furthermore, the communications network 12 may comprise one or more fixed networks or the Internet.

The information system 50 may comprise at least one information server 51. The identification server system 51 may also comprise one or more other network devices (not shown), such as a terminal device, a server, and/or database devices. The information server system 51 is configured to communicate with one or more user devices 10, 20 via the communications network 12. The information server system 51 may also be implemented as distributed server system comprising two or more separate servers or as a computing cloud comprising one or more cloud servers. In some embodiments, the information server system 51 may be a fully cloud-based server system. Further, it should be appreciated that the location of the information server system 51 is irrelevant to the invention. The information server system 51 may be operated and maintained using one or more other network devices in the system or using a terminal device (not shown) via the communications network 12.

The information server system 51 may comprise an information database 58. The information server system 51 or server and the information database 58 may form a single database server, that is, a combination of a data storage (database) and a data management system, as in FIG. 1, or they may be separate entities. The data storage may be any kind of conventional or future data repository, including distributed and/or centralised storing of data, cloud-based storage in a cloud environment (i.e., a computing cloud), managed by any suitable data management system. The detailed implementation of the data storage is irrelevant to the invention, and therefore not described in detail.

The information server system 51 may also comprise a processing module 52. The processing module 52 is coupled, or otherwise has access, to a memory module 54. The processing module 52 and the memory module 54 may form the information server, or at least part of it. The processing module 52 may be configured to carry out instructions of information applications or units by utilizing instructions of the information application. The information server system 51 may comprise an information unit 56 which may be the information application. The information application 56 may be stored in the memory module 54 of the information server system 51. The information application or unit 56 may comprise the instructions of operating the information application. Thus, the processing module 52 may be configured to carry out the instructions of the information application.

The processing module 52 may comprise one or more processing units or central processing units (CPU) or the like computing units. The present invention is not restricted to any kind of processing unit or any number of processing units. The memory module 54 may comprise a non-transitory computer-readable storage medium or a computer-readable storage device. In some embodiments, the memory module 54 may comprise a temporary memory, meaning that a primary purpose of memory module 54 may not be long-term storage. The memory module 54 may also refer to volatile memory, meaning that memory module 54 does not maintain stored contents when the memory module 54 is not receiving power. Examples of volatile memories include random access memories (RAM), dynamic random access memories (DRAM), static random access memories (SRAM), and other forms of volatile memories known in the art. In some examples, the memory module 54 is used to store program instructions for execution by the processing module 52, for example, the information application. The memory module 54, in one embodiment, may be used by software (e.g., an operating system) or applications, such as software, firmware, or middleware. The memory module 54 may comprise for example operating system or software application, the information application, comprising at least part of the instructions for executing the method of the present invention.

The information server system 51 may also comprise a processing module 52. The processing module 52 is coupled to or otherwise has access to a memory module 54. The processing module 52 and the memory module 54 may form the identification server or at least part of it. The information server, or the processing module 52 and/or the memory module 54, has access to the information database 58. The processing module 52 may be configured to carry out instructions of information applications or units by utilizing instructions of the identification application. The information server system 50 may comprise an information unit 56 which may be the information application. The information application 56 may be stored in the memory module 54 of the information server system 150. The information application or unit 56 may comprise the instructions of operating the information application. Thus, the processing module 52 may be configured to carry out the instructions of the information application.

It should be noted, that the information database 58 may also be configured to comprise software application, the identification application, comprising at least part of the instructions for executing the present invention.

The information database 58 may maintain information of input inquiries and/or output responses. The information database 18 may also maintain information of one or more user accounts of a plurality of users and/or information uploaded to the server system 51 via said user accounts or user devices 10, 20. The information database 58 may comprise one or more storage devices. The storage devices may also include one or more transitory or non-transitory computer-readable storage media and/or computer-readable storage devices. In some embodiments, storage devices may be configured to store greater amounts of information than memory module 54. Storage devices may further be configured for long-term storage of information. In some examples, the storage devices comprise non-volatile storage elements. Examples of such non-volatile storage elements include magnetic hard discs, optical discs, solid-state discs, flash memories, forms of electrically programmable memories (EPROMs), or electrically erasable and programmable memories (EEPROMs), and other forms of non-volatile memories known in the art. In one embodiment, the storage device may comprise databases and memory module 54 comprise instructions and operating information applications for executing the present invention utilizing the processing unit 52. However, it should be noted that the storage devices may also be omitted and the information server system 51 may comprise only the memory module 54, which also is configured to maintain the information database 58. Alternatively, the memory module 54 could be omitted and the information server system 51 could comprise only one or more storage devices. Therefore, the terms memory module 54 and information database 58 could be interchangeable in embodiments in which they both are not present. The information database 58 is operable with other components and data of the information server system 51 by utilizing instructions stored in the memory module 54 and executed by the processing unit 52 over the communications network 12.

The information database 58 may be provided in connection with the information server or the identification server 51 may comprise the information database 58. Alternatively, the information database 58 may be provided as an external database 58, external to the information server system 51, and the information database 58 may be accessible to and connected to the information server system 51 directly or via the communications network 12.

The storage device(s) may store one or more information databases 58 for maintaining information. These different information items may be stored in different database blocks in the information database 58, or alternatively, they may be grouped differently.

Users may utilize the system of the present invention with the user devices 10, 20 as shown in FIG. 1. The user devices 10, 20 are configured to connect with or access the information server system 12 via the communications network 12. The user devices 10, 20 may be a personal computer, desktop computer, laptop, or user terminal, as well as a mobile communication device, such as a mobile phone or a tablet computer suitable for performing web browsing or capable of accessing and interacting with the information server system 51. However, the user devices 10, 20 may also be a personal digital assistant, thin client, electronic notebook, or any other such device having a display and interface and being suitable for performing web browsing or capable of accessing and interacting with the information server system 51. The user devices 10, 20 may refer to any portable or non-portable computing device. Computing devices that may be employed include wireless mobile communication devices operating with or without a subscriber identification module (SIM) in hardware or in software. Further, the user devices 10, 20 may also be intelligent or automated, and for instance could be cars, airplanes, drones, satellites, virtual assistants, and the like.

Accordingly, in the context of the present invention, the term user device comprises user devices operated by human users as well as intelligent or automated user devices or systems, which can operate without the direct interaction of/with a human user.

The user devices 10, 20 are configured to enable data transfer connection with the information server system 51.

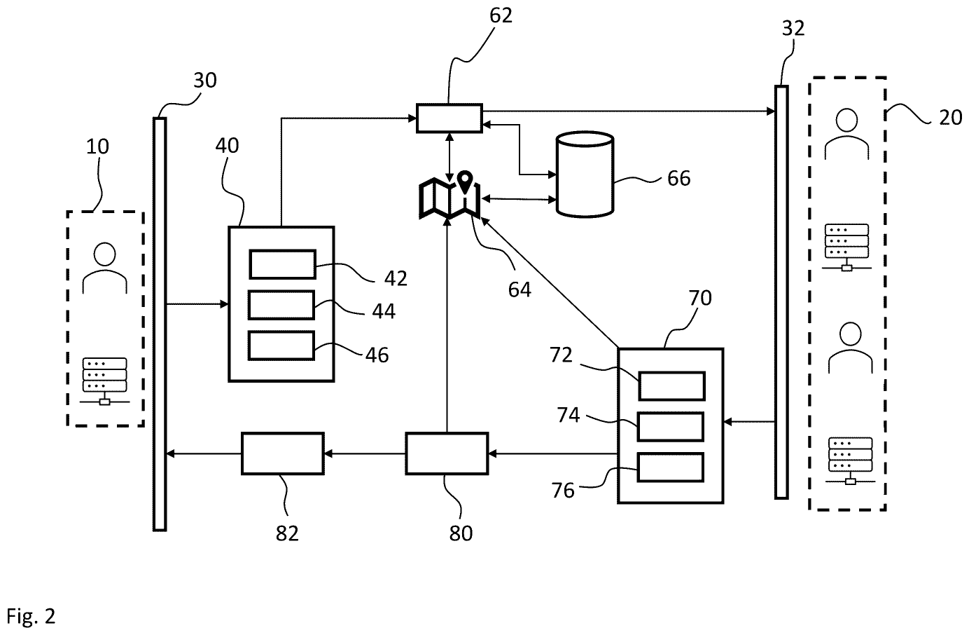

As shown in FIG. 2, the user devices 10, 20 comprise a user interface 30, 32. The user interface 30, 32 may be any suitable user interface for a human user to utilize and interact with the information server system 51 or for an intelligent user device 10, 20 to utilize and interact with the information server system 51 for carrying out the present invention. The user interface 30, 32 may be a graphical user interface (GUI) provided by a web browser or a dedicated application on a display (e.g., a monitor screen, LCD display, etc.) of the user device 10, 20 in connection with the information provided by the information server system 51 or other systems or servers. The user interface 30, 32 may, for example, enable the users' input messages or data, upload and/or download data files and input images and information, provide inquiries and receive responses and notifications.

The user interface 30, 32 may be accessible by the user with an input device (not shown) such as touchscreen, keyboard, mouse, touchpad, keypad, trackball, or any other suitable hand-operated input device or some other kind of input devices such as voice operable user device or human gesture, such as hand or eye, gesture detecting input device. The input device may be configured to receive input from the user or an intelligent device.

The user interface 30, 32 may also be an interface towards and accessible to an imaging device or camera of the user device 10, 20. Thus, the information server system 51 may be accessible to the camera of the user device 10, 20 and arranged to receive one or more images obtained with the camera of the user device 10, 20.

The user devices 10, 20 may in some embodiments comprise a user application such as a software application, stored in a user device memory, and executed with a user device processor.

Furthermore, the system of the present invention may be configured to interact with an external service or third party service over the communications network 12 and suitable communication protocol. In the present invention, the external service may be for example an external map service, an external database, or the like.

FIG. 2 shows schematically the information system according to the present invention and operation of the same.

The information server system 51 is configured to receive an input inquiry from an input user device 10 via an input user interface 30.

The input inquiry comprises input text corpus defining the inquiry.

The information system 50 is first configured to determine information included in the input inquiry. Therefore, the information system is configured to comprehensively understand the input inquiry by deriving all possible metadata, and possibly, even augment the context-related metadata or information from the original input inquiry.

The information system 50 comprises an input context generator 40 in which the received input inquiry is inputted. The input context generator 40 comprises an input context detector 42, an input context enhancer 44, and an input location detector 46.

As mentioned above, the input context generator 40 is configured to derive and generate metadata from the input inquiry and the input text corpus thereof to ensure the best possible understanding of the input inquiry domain, and this is achieved by analysing the input inquiry in the input text corpus format.

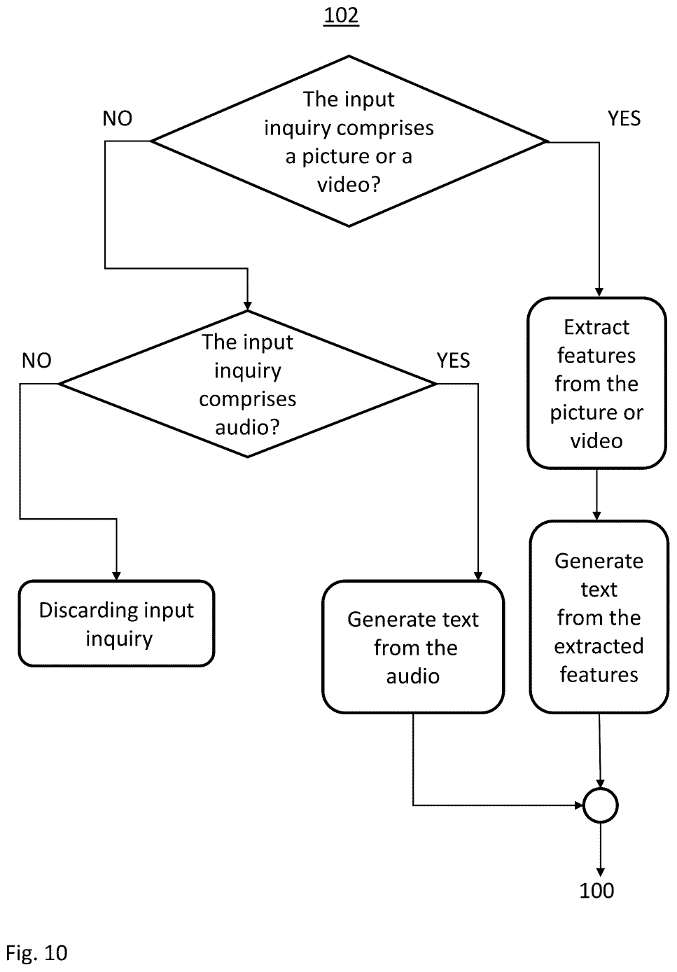

If the input inquiry comprises one or more images, video, or audio data, the information system 50 is configured to extract the features from the one or more images or video data or audio data, and generate text description based on the one or more images, video, or audio data and incorporate the text description into the input text corpus of the input inquiry, as shown in FIG. 10 and in system step 102.

In a case where the input inquiry comprises image data or video data, and the information system 50 or the input context generator 40 is configured to extract features from the image or video data for example with an image recognition algorithm and/or with optical character recognition algorithm and/or image to text algorithm. The information system 50 or the input context generator 40 is further configured to generate an image text description from the image data or video data and incorporate the image text description generated from the image data or video data to the input text corpus.

In a case where the input inquiry comprises image data or video data, and the information system 50 or the input context generator 40 is configured to generate an audio text description from the audio data and incorporate the audio text description generated from the audio data to the input text corpus. The audio text description may be carried out for example by utilizing a speech recognition algorithm and/or audio to text algorithm.

Accordingly, in cases where the input inquiry comprises audio, the information system 50 or the input context generator 40 is configured to apply speech-to-text techniques and to generate the audio text description or transcript of the audio content. In the preferred embodiment, once the system generated the input inquiry into a text-only format, the input text corpus is inputted to the input context generator detector 42.

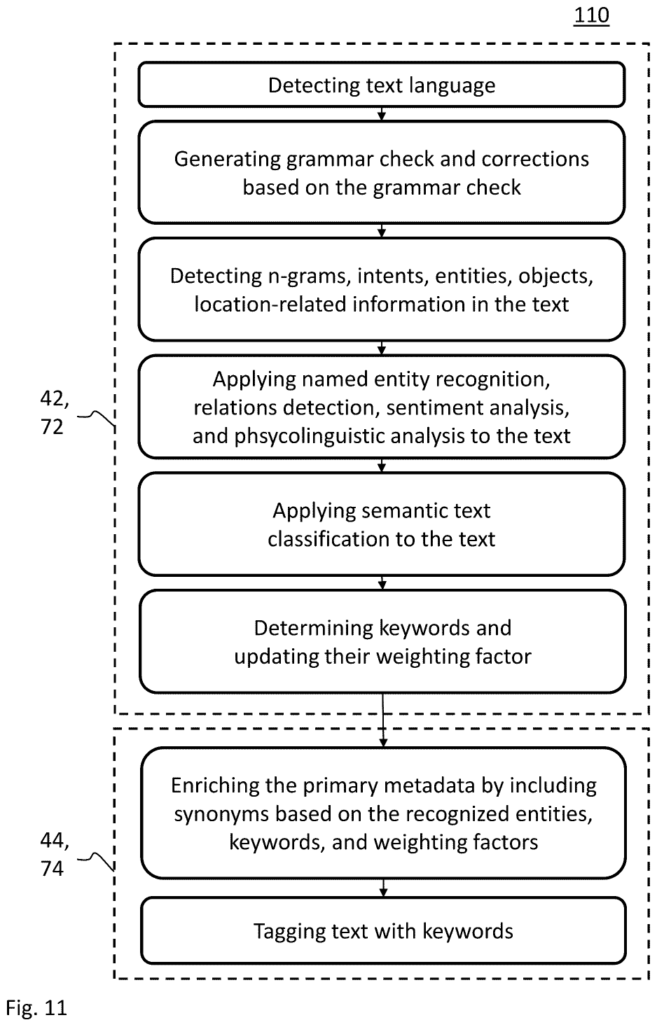

The operation of the input context detector 42 is shown schematically in FIG. 11 as a system step 110. The input context detector is configured to generate primary input inquiry metadata. The primary input inquiry metadata comprises one or more primary input text objects generated from the input text corpus of the input inquiry. The input context detector 42 is configured to carry out one or more of detecting the language of the input text corpus, dividing the input text corpus to n-grams, and identifying keywords in the input text corpus. The one or more primary input text objects comprising the n-grams and/or the keywords.

In some embodiments, the input context detector 42 is configured to detect the language of the text corpus of the input inquiry. Then, based on the detected language, the input context detector 42 is configured to carry out a grammar check of the input text corpus and eventually apply appropriate corrections, and/or a translation to a language of reference, to the input text corpus. Subsequently, the input context detector 42 is configured to detect n-grams, intents, and entities, and apply object recognition to input text corpus, and detect location-related information in the input text corpus. Further, the input context detector 42 is configured to apply named entity recognition techniques, and the like, to detect and derive relations among the words in an input text corpus, and then to also apply techniques of sentiment analysis, psycholinguistic text analysis, and the like, to generate the input inquiry metadata from the input text corpus. Furthermore, the input context detector 42 is configured to apply semantic text classification to the input text corpus, determine the keywords, and update their weighting factors. The input context detector 42 may be configured to carry out one or more of the above-disclosed system steps to generate input inquiry metadata having the keywords and the n-grams as input text objects.

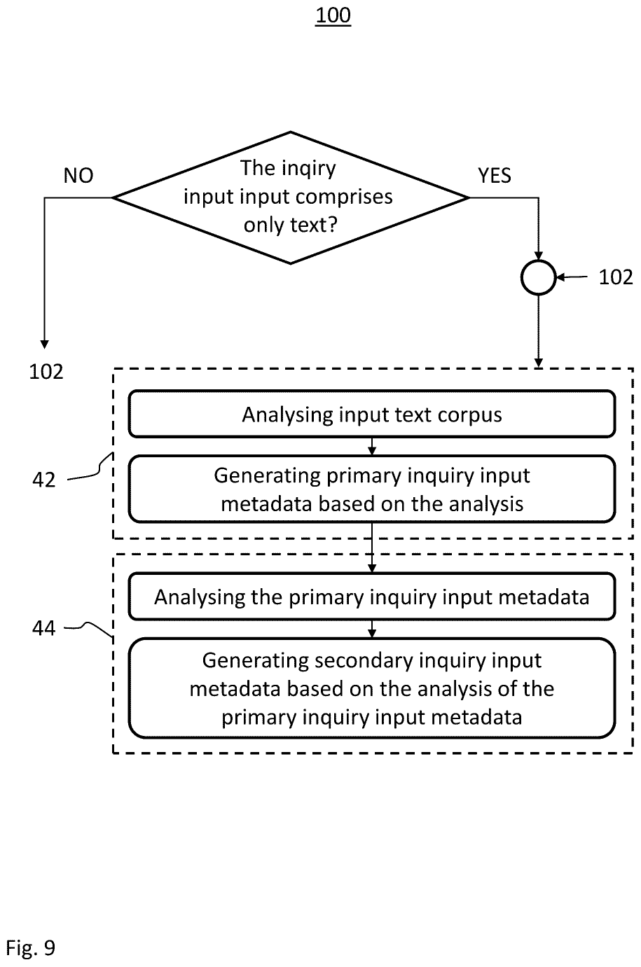

The operation of the input context enhancer 44 is also shown schematically in FIGS. 9 and 11 as the system steps 100 and 110, respectively. The input context enhancer 44 is configured to generate secondary input inquiry metadata. The secondary input inquiry metadata comprising one or more secondary input text objects generated from the one or more primary input text objects of the primary inquiry metadata, the input context enhancer is configured to carry out determining synonyms for the n-grams in the primary input inquiry metadata, and determining synonyms for the keywords in the primary input inquiry metadata.

In some embodiments, the input context enhancer 44 is configured to enrich the primary input inquiry metadata by including relevant synonyms based on the recognized entities, keywords, and their weighting factors. Further, the input context enhancer 44 is configured to tag or categorize the input text corpus with all the relevant keywords for tagging purposes.

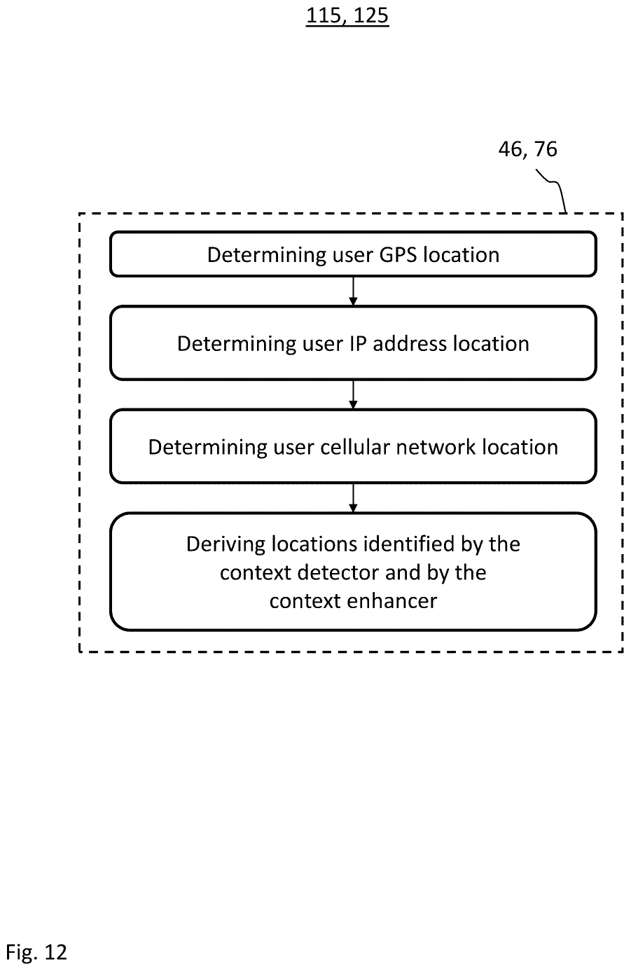

The input location detector 46 is configured to determine the input location of the input user device 10 as shown in FIG. 12 as a system step 115. The input location detector 46 is configured to determine input user device 10 GPS location, the input user device IP address location, the input user device cellular network location, and/or the location of the input user device 10 by deriving the location from the input inquiry or the input inquiry metadata.

In some embodiments, the input inquiry comprises location metadata which comprises GPS metadata, IP address metadata, or cellular network metadata for determining the input location.

Accordingly, the information system 50 and the input location detector 46 are configured to determine the input location of the input user device 10 and thus from where the input inquiry has originated.

The input location detector 46 in one embodiment is configured to determine input location through GPS or A-GPS and the like, which are expected to be generally available on the originator device. Depending on the possible embodiment, complementary or alternatively, the input location detector 46 is configured to determine the user device network IP address location, and further determine, whenever available, the location of the nearest cellular network or antenna, as this would represent another approximation of the location from where the input inquiry has originated. Finally, the input location detector 46 is configured to derive and enrich the metadata with any location-related detail or information that is directly extracted from the initial inquiry itself by the input context generator 40.

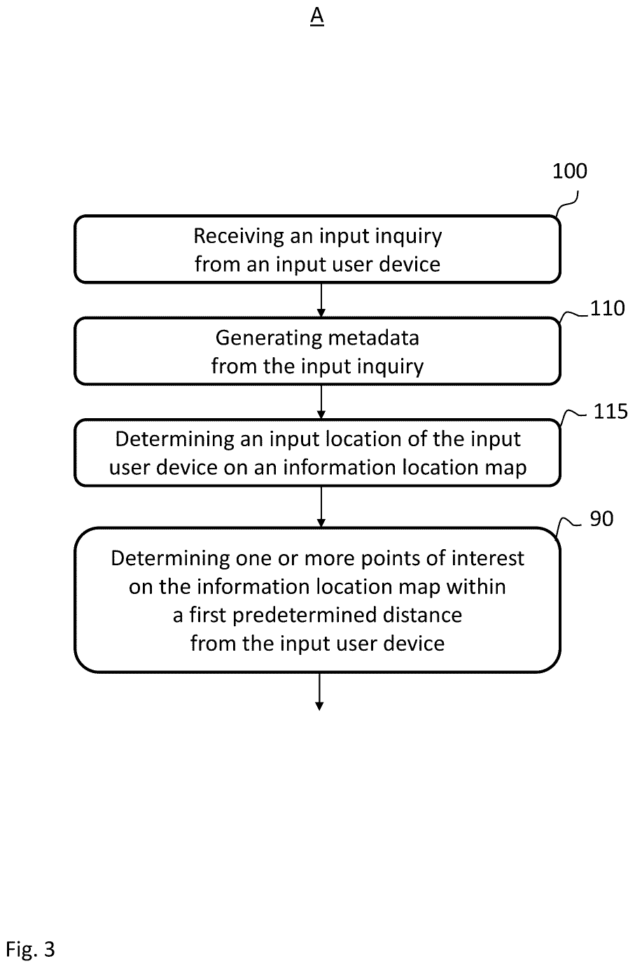

The information system 50 further comprises a map locator 62 configured to determine one or more points of interest on an information location map 64 within a first predetermined distance from the input location based on the input inquiry, primary input inquiry metadata, and second input inquiry metadata, as disclosed in FIG. 3 with system steps 100, 110, 115, and 90 in a process A.

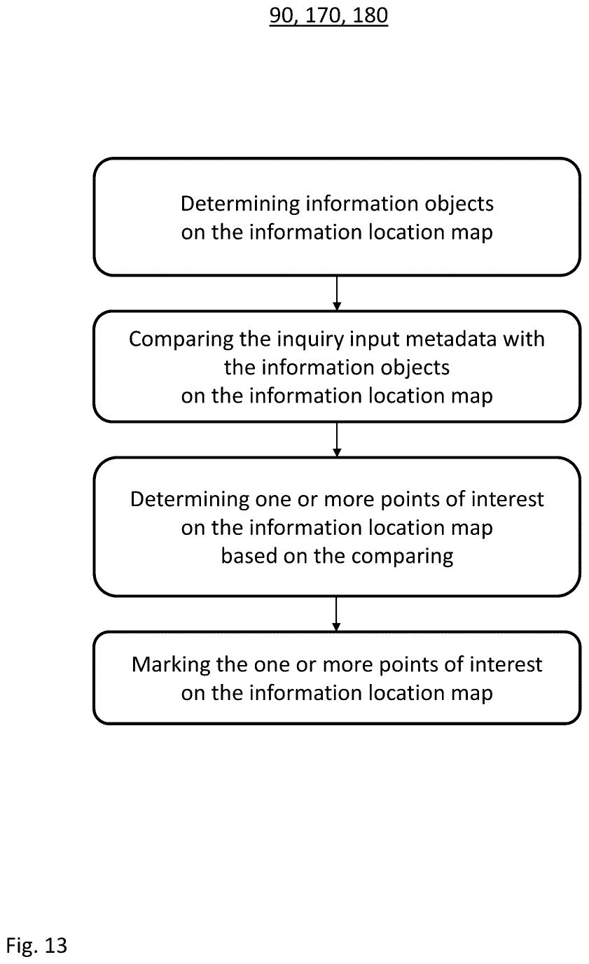

In some embodiments, the information location map 64 comprises an area map and information objects associated with area locations on the information location map 64. The map locator 62 is configured to determine one or more points of interest, as shown in FIG. 13 as system step 90, by comparing the one or more input text objects of the primary and secondary input inquiry metadata with the information objects of the information location map 64, and determining the one or more points of interest on the information location map 64 based on the comparing. The one or more points of interest are associated with an information object on the information location map 64 which matches with an input text object of the primary or secondary input inquiry metadata.

In an alternative embodiment, the information system 50 comprises a known places database 66, as shown in FIG. 2. The known places database 66 may be an internal database provided in the information server system 51, or an external database accessible by the information server system 51. The known places database 66 is configured to maintain information objects having associated area location information. The map locator 62 is configured to determine the one or more points of interest on the information location map 64 by comparing the one or more input text objects of the primary and secondary input inquiry metadata with the information objects of the known places database 66. The map locator 62 is further configured to determine a matching information object in the known places database 66 based on comparing the one or more primary input text objects of the primary input inquiry metadata and the one or more secondary input text objects of the secondary input inquiry metadata with the information objects of the known places database 66, and determine the one or more points of interest on the information location map 64 based on the location information associated with the matching information object.

Accordingly, the map locator 62 is configured to locate the one or more points of interest locations on the information location map 64. The map locator 62 is configured to determine known places by querying a known places database 66 to retrieve all the positions of the one or more points of interest that are located near the input location of the input user device 10. This would ensure further points from where to start looking for a valid response to the input inquiry.

The information system 50 comprises an output context generator 70. The output context generator 70 comprises an output context detector 72, an output context enhancer 74, and an output location detector 76.

When the one or more points of interest are determined on the information location map based on the input inquiry, the information system or the output locator is configured to detect output user devices near the one or more points of interest, with a predetermined output distance from the one or more points of interest.

The output location detector 76 is configured to determine the output location of output user devices 20 as shown in FIG. 12 as a system step 125. The output location detector 76 is configured to determine output user device 20 GPS location, the output user device IP address location, or the output user device cellular network location.

Accordingly, the information system 50 and the output location detector 76 are configured to determine the output location of the output user devices 20 near the determined one or more points of interest on the information location map 64. This ensures that the responses will be received only from output user devices 20 which are close to the determined one or more points of interest.

The output location detector 76 in one embodiment is configured to determine output location through GPS or A-GPS and the like, which are expected to be generally available on the originator device. Depending on the possible embodiment, complementary or alternatively, the output location detector 76 is configured to determine the user device network IP address location, and further determine, whenever available, and the location of the nearest cellular network or antenna, as this would represent another approximation of the location of the output user devices 20.

The map locator 62 is further configured to determine output user devices 20 near the one or more points of interest based on the output locations of the output user devices 20.

The map locator 62 is also configured to mark all the detected output user devices 20 on the information location map 64.

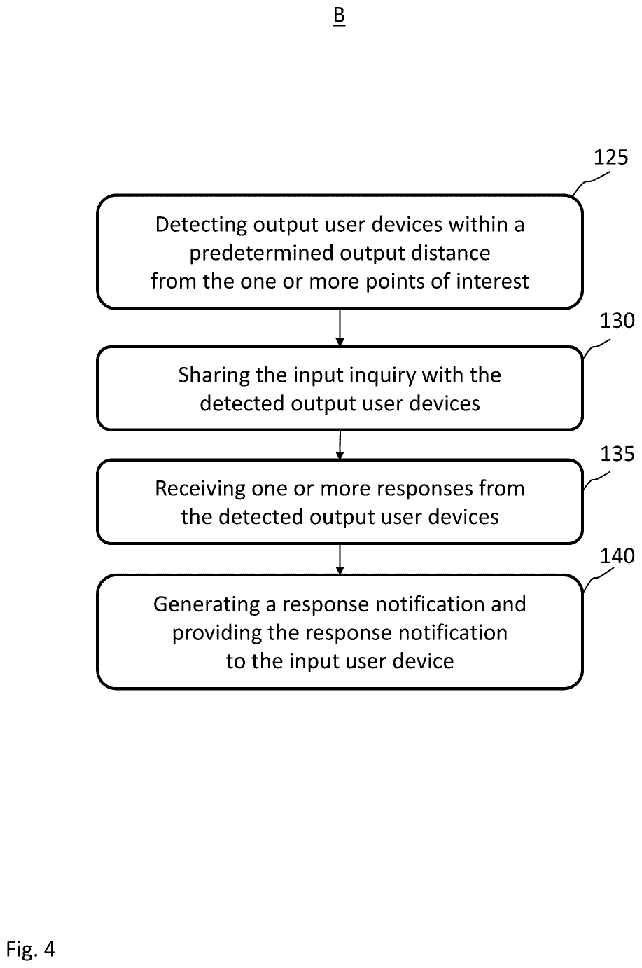

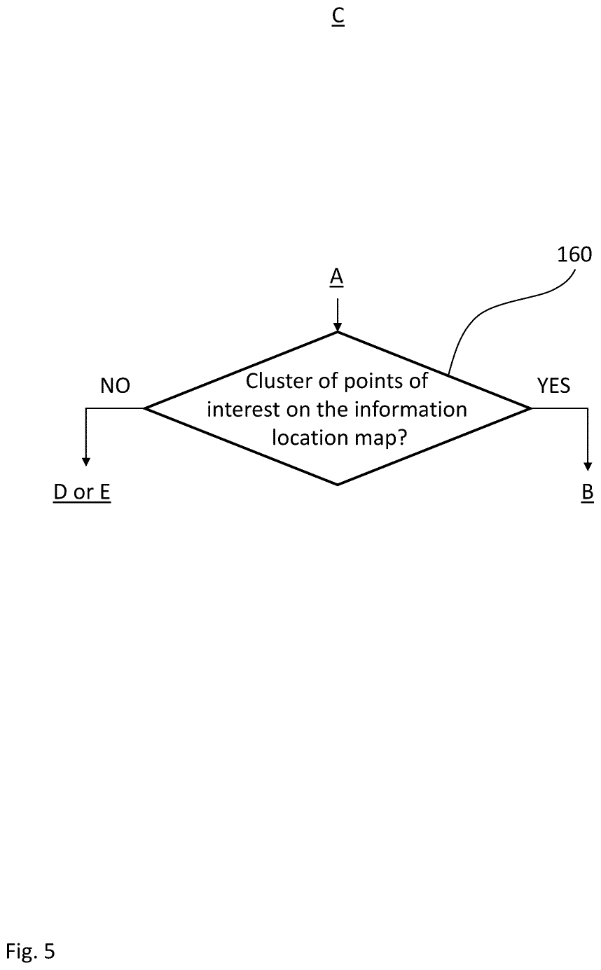

Then, the information system 50 is configured to share the input inquiry with the detected output user devices 20 within the predetermined output distance from the one or more points of interest, and receive one or more responses from the output user devices 20 within the predetermined output distance from the one or more points of interest, as shown in FIG. 4 with system steps 125, 130, 135 of process B. The information system 50 is further configured to generate a response notification in system step 140 based on the one or more responses received from the output user devices 20 and provide the response notification to the input user device 10.

The information server system 51 is configured to receive the responses from the output user devices 20 via an output user interface 32.

The information system 50 is further configured to locate the received responses on the information location map 64.

The one or more received responses comprise output text corpus, and the output context generator 70 is configured to generate output response metadata for the received one or more responses by analysing the output text corpus of each of the received one or more responses, the output response metadata comprising one or more output text objects generated from the output text corpus of the one or more responses, respectively. The output response metadata, primary output response metadata, and secondary output response metadata are generated similarly as in the input response metadata, primary input response metadata, and secondary input response metadata, as disclosed above and in connection with FIG. 11.

The map locator 62 is configured to determine a response location or output location on the information location map by comparing the one or more output text objects of the output response metadata and/or primary output response metadata and/or secondary output response metadata with the information objects of the information location map 64, and by determining the response location on the information location map 64 based on the comparing. The map locator 62 is further configured to associate the response location to an information object on the information location map 64 matching with an output text object of the output response metadata.

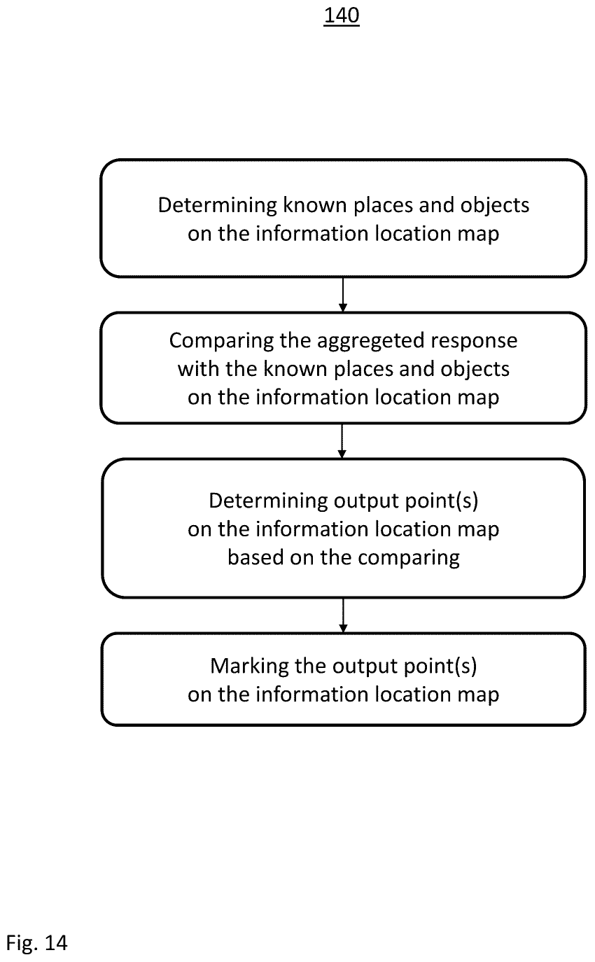

Alternatively, the map locator 62 is configured to determine the response locations on the information location map 64 by comparing the one or more output text objects of the output response inquiry metadata with the information objects of the known places database 66, determining a matching information object in the known places database 66 based on comparing the one or more output text objects of the output response metadata with the information objects of the known places database 66, and by determining the output location on the information location map 64 based on the location information associated with the matching information object, as shown in FIG. 14 with a system step 140.

The information system 50 is configured to provide the one or more responses to the input user device 10 or input user together with the response location. Thus, the input user receives both the response and location associated with the one or more responses.

The map locator 62 or the information system 50 is further configured to mark the response location on the information location map 64 and provide or display the information location map 64 with the marked response location to the input user or input user device 10.

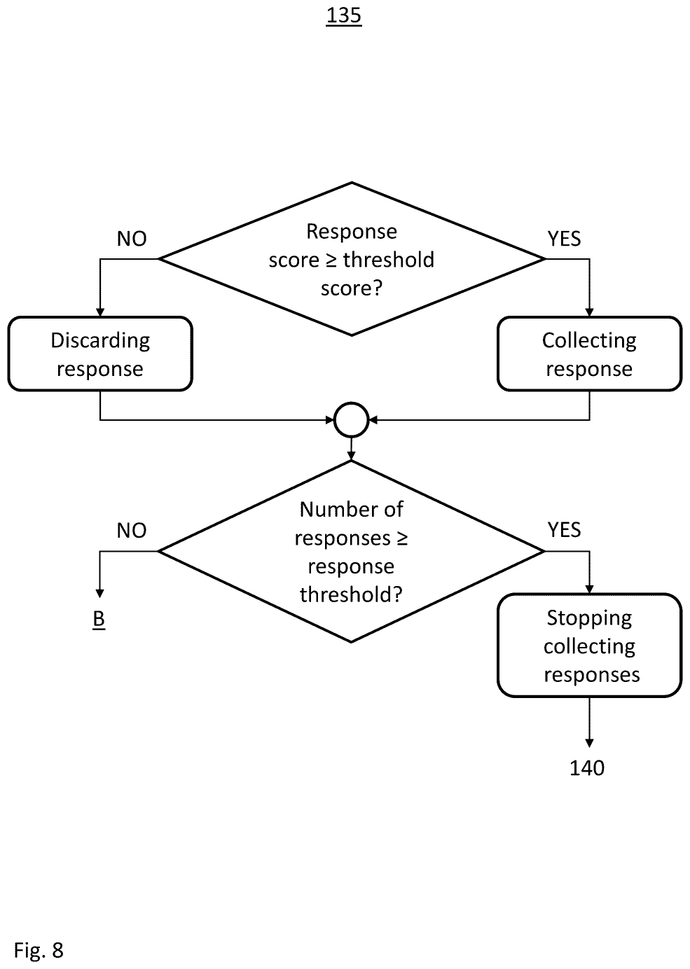

All the received responses may not contain valid information or valid responses. Therefore, the information system 50 comprises response collector 80, as shown in FIG. 2. The response collector 80 is configured to perform a scoring of the responses based on coherence with respect to the context of the input inquiry and the received response. The response collector 80 is configured to maintain a pre-determined response score threshold representing a coherence value between the input inquiry and the received response. The response collector 80 is further configured to receive one or more candidate responses from the output user devices 20, or from the output context generator 70 together with the output response metadata, determine a response score for each of one or more candidate responses by comparing the output text corpus of each of the one or more candidate responses with the input text corpus of the input inquiry, or the output text corpus and output response metadata of each of the one or more candidate responses with the input text corpus and input inquiry metadata of the input inquiry. The response collector 80 is further configured to compare the response score of each of the candidate responses with the pre-determined response score threshold, and based on the comparing the response collector 80 is configured to discard the candidate response if the response score of the candidate response is below the pre-determined response score threshold, or store the candidate response as a qualified response if the response score of the candidate response is above the pre-determined response score threshold, as shown in FIG. 8 with system step 135.

Thus, only qualified responses will be stored. The output location may also be determined only for the qualified responses.

The response collector 80 may also be configured to perform a tally of the number of received or qualified responses to ensure that a necessary number of responses is received. The response collector 80 is configured to maintain a pre-determined response number threshold representing a number of required responses. The response collector 80 is further configured to calculate a number of received responses or qualified responses and, if the number of received responses or qualified responses is above the first pre-determined response number threshold, to stop collecting responses, and to then share all the collected qualified responses with the response aggregator 82 that will generate a cumulative and/or combined response, and a response notification based on the received responses or qualified responses and provide the response notification to the input user device, as shown in FIG. 8.

If the number of received responses or qualified responses is below the first pre-determined response number threshold, the information system 50 is configured to determine, with the map locator, subsequent one or more points of interest on the information location map 64 within the predetermined distance from the previous one or more points of interest based on the one or more input text objects of the input inquiry metadata and the information location map 64. Accordingly, the previous one or more points of interest become the centre and the subsequent one or more points of interest are determined. After that, the information system 50 is configured to repeat the process B and system steps 125, 130, 135 as shown in FIG. 4 with regards to the subsequent one or more points of interest.

In some cases, the information system 50 is configured to detect a cluster of responses on the information location map 64. The cluster means two or more responses having the same response location or associated to the same information object of the information location map 64. In this case, the responses are received until a cluster is detected.

Therefore, the response collector 80 is configured to detect the cluster of response locations on the information map 64 by comparing the response locations of the received responses or qualified responses, and if a cluster of response locations is detected on the information location map, the received responses or qualified responses are shared with the response aggregator 82 that will generate a final combined response, thereby generating the response notification based on the responses associated with the cluster and providing the response notification to the input user device.

If a cluster of response locations is not detected on the information location map, the information system 50 is configured to determine, with the map locator, subsequent one or more points of interest on the information location map within the predetermined distance from the previous one or more points of interest based on the one or more input text objects of the input inquiry metadata and the information location map 64. Accordingly, the previous one or more points of interest become the centre and the subsequent one or more points of interest are determined. After that, the information system 50 is configured to repeat process B and system steps 125, 130, 135 as shown in FIG. 4 with regards to the subsequent one or more points of interest for finding the cluster.

In some cases, only 1 to 3 responses or qualified responses are received from the output user devices 20. In this case, all the separate responses may be provided to the input user together with the response location of each of the responses.

Alternatively, in some embodiments, when two or more responses are received from the output user devices, a single response is generated based on the received responses or qualified responses.

The information system 50 comprises a response aggregator 82. The response aggregator 82 is configured to aggregate the one or more received responses or qualified into a single response, determine an aggregated response location for the single response based on the response locations of the received responses or the qualified responses, and associate the aggregated response location with the single response.

When a cluster is detected, the response aggregator 82 is configured to aggregate the one or more responses associated with the cluster into a single response, determine an aggregated response location for the single response based on the response locations of the responses associated with the cluster, and associate the aggregated response location with the single response.

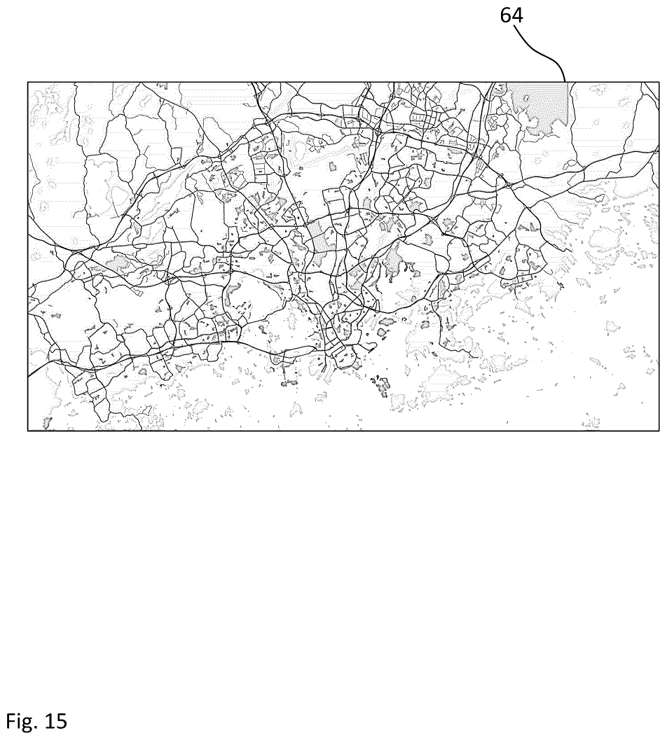

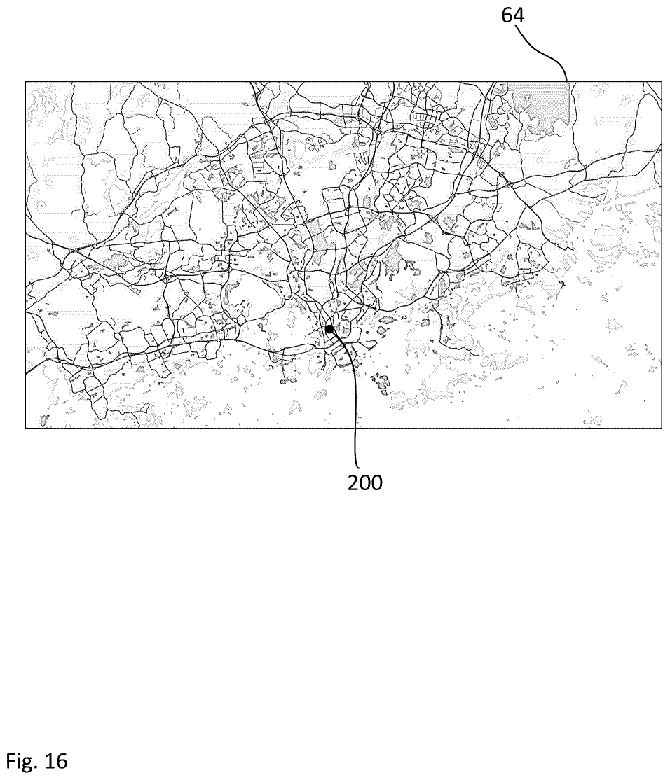

Figures from 15 to 22 disclose schematic visual representations of the operation of the information system 50 according to the present invention. FIG. 15 shows an empty information location map 64. FIG. 16 shows an input location 200 of the input user device 10 determined by the input location detector 46 after receiving input inquiry.

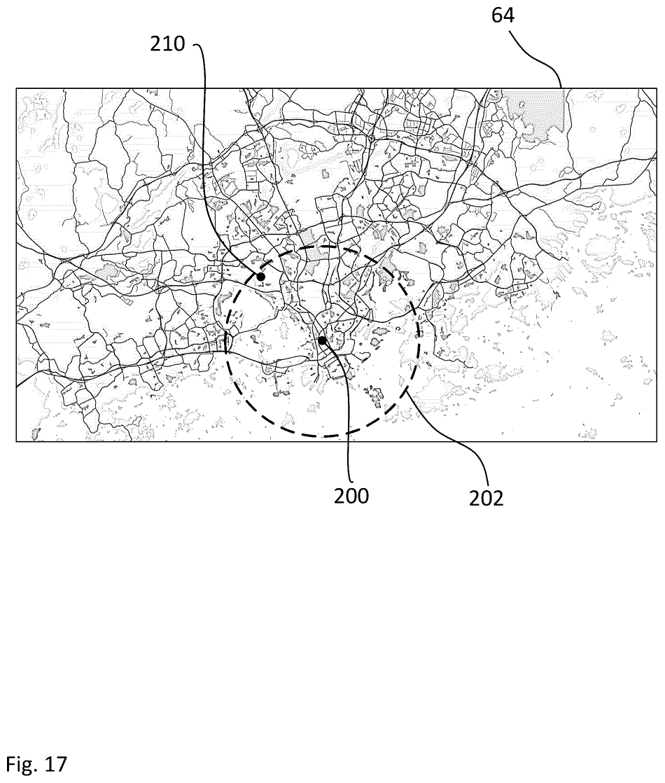

FIG. 17 shows a point of interest 210 within a first predetermined distance 202 from the input location 200 on the information location map 64. The point of interest 210 is determined by the map locator 62 based on the input inquiry, the input inquiry metadata, or the primary input inquiry metadata and secondary input inquiry metadata.

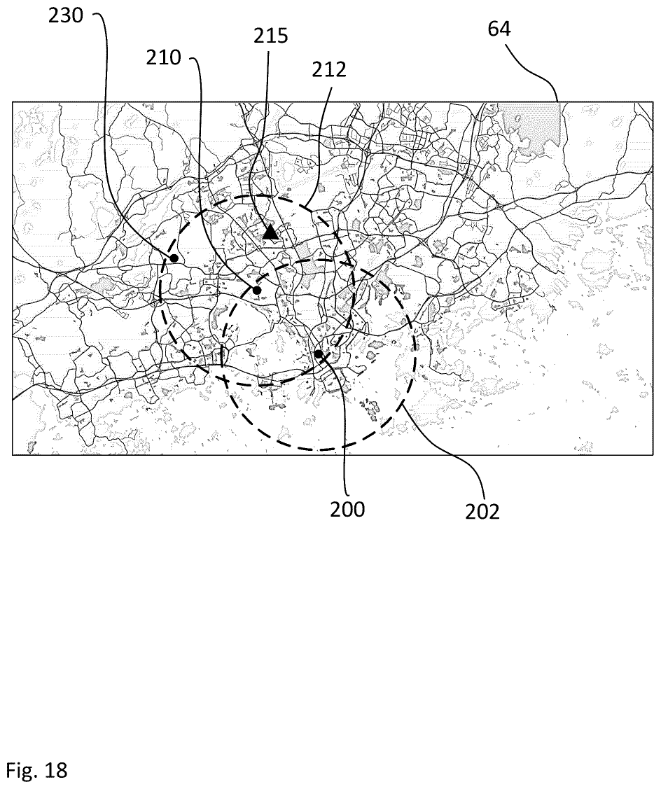

FIG. 18 shows a detected output user device 215 within a predetermined output distance 212 from the determined point of interest 210. A response is received from the detected output user device 215 and a response location 230 on the information location map 64 is determined for the received response based on the output text corpus, the output response metadata, or the primary output response metadata and secondary output response metadata.

Accordingly, the response is received from the output user device close to the point of interest and the response is provided with output location 230 comprising information of the location relating to the response. This one response is considered a qualified response.

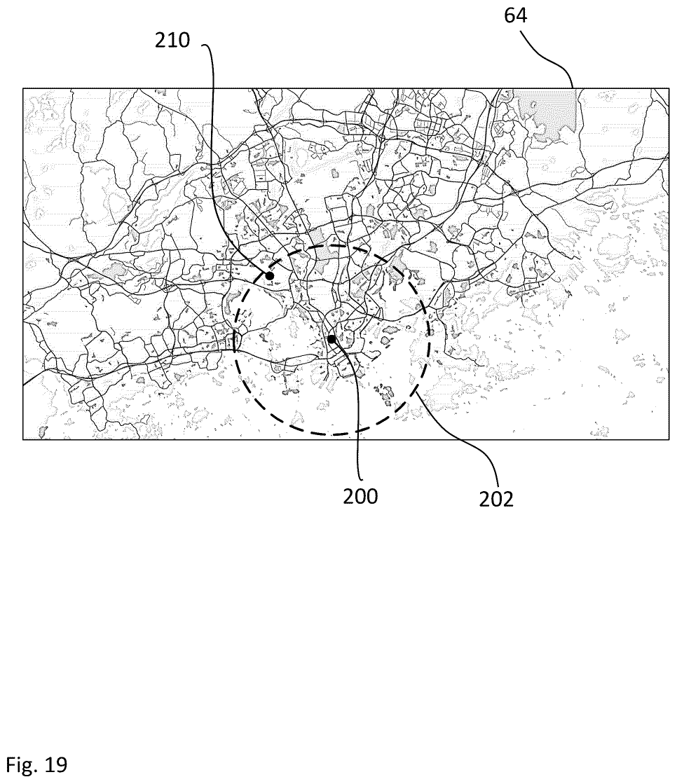

FIGS. 19 to 22 disclose a solution in which a cluster of at least two responses is required.

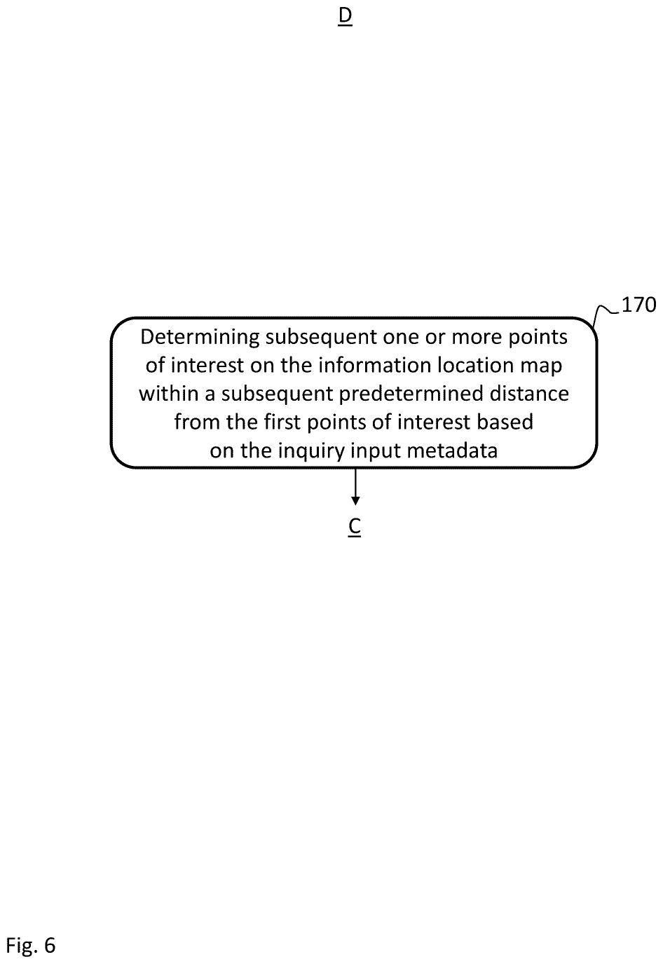

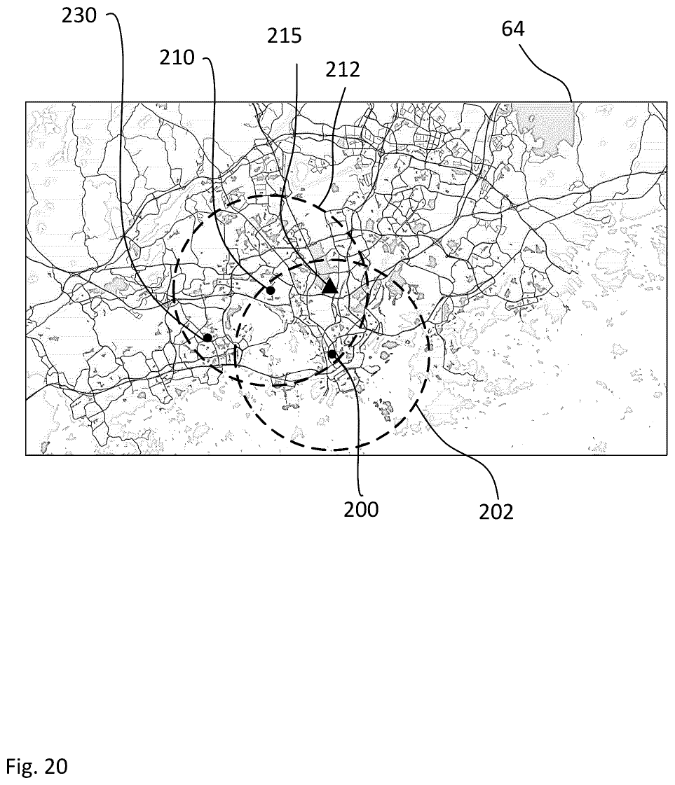

FIGS. 19 and 20 disclose a similar situation as in FIGS. 17 and 18. As seen in FIG. 20 only one output user device 215 is detected and therefore only one response with a response location 230 is received. As only one response is received, this response does not qualify as a cluster of responses. Thus, subsequent points of interest are determined by the information system 50 as shown in process D in FIG. 6 with a system step 170.

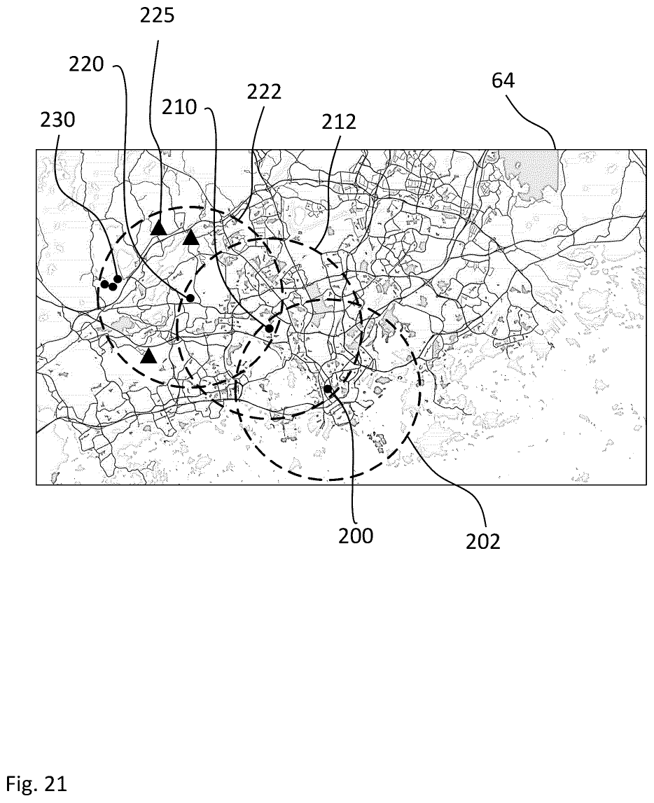

Therefore, the information system 50 is configured to determine 90, with the map locator 62, a subsequent point of interest 220 on the information location map 64 within the predetermined distance 212 from the previous point of interest 210 based on the one or more input text objects of the input inquiry metadata and the information location map 64. FIG. 21 shows a detected output user device 225 within the predetermined output distance 222 from the determined subsequent point of interest 220. Multiple responses are received from the detected output user devices 225 and respective response locations 230 on the information location map 64 are determined for the received responses based on the output text corpus of the responses, the output response metadata, or the primary output response metadata and secondary output response metadata of the responses.

As shown in FIG. 21, the responses 230 form a cluster on the information location map 64. Thus, the qualified responses are received as a cluster response location 230 is detected on the information location map 64.

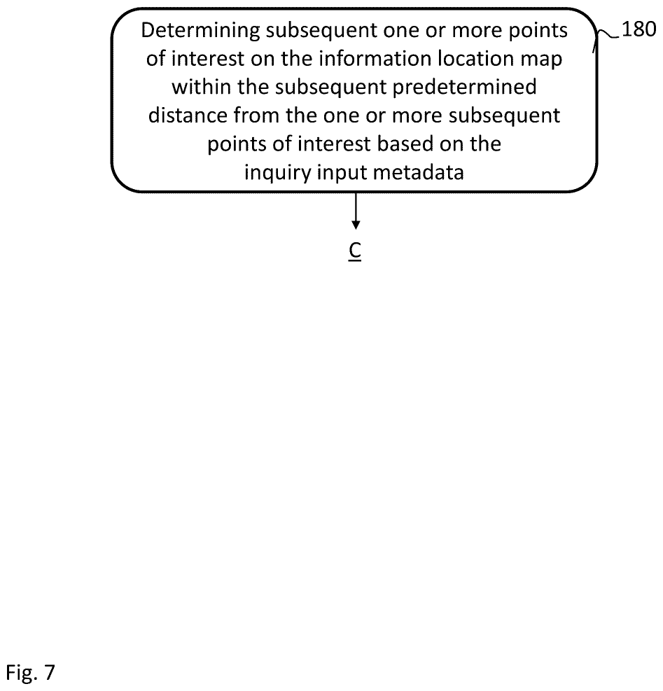

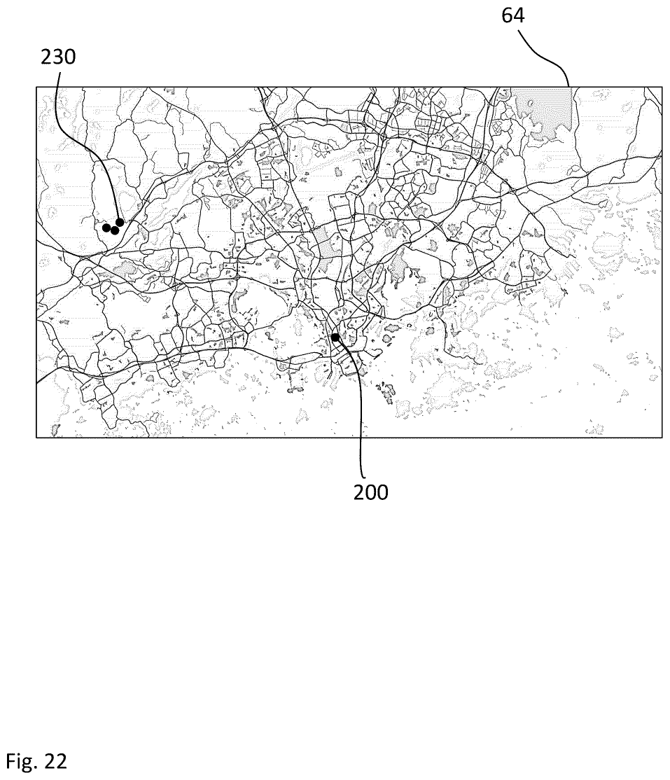

FIG. 22 further shows the input location 200 and the response location 230 of the qualified responses. In a case when a cluster is not still found, further subsequent points of interest are determined by the information system 50 as shown in process E of FIG. 7 with a system step 180.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

It should be understood that the system and method herein described can be implemented with current and future technologies, and at present would be easily implemented, by a person having ordinary skill in the art, e.g. as a computer or mobile app, as a social search engine, as a web application, as a set of APIs, or as an integration to existing web-services or applications, and the like.

Further, it is worth noting that the system is meant to primarily work with information that is mainly accessible offline, meaning it is meant to discover information that is not available online or on the internet to anyone yet, and aims at discovering the locations where the response to a specific inquiry or search query is physically located, thereby providing the response (information) and its physical or virtual location (information' location(s)).

Finally, the descriptions of the various embodiments of the present invention have been presented for purposes of illustration but are not intended to be exhaustive or limited to the embodiments disclosed. Many modifications and variations will be apparent to those having ordinary skill in the art without departing from the scope and spirit of the described embodiments. The terminology used herein was chosen to best explain the principles of the embodiments, the practical application or technical improvement over technologies found in the marketplace, or to enable others having ordinary skill in the art to understand the embodiments disclosed herein.

1-21. (canceled)

22. An information system for question answering, information retrieval, and location discovery, the information system comprising one or more processors and a memory storing instructions for execution by the one or more processors, wherein the information system is configured to:
maintain an information location map, the information location map comprising an area map;
carry out process A) comprising:
receive an input inquiry from an input user device, the input inquiry comprising input text corpus,
generate, with an input context generator, input inquiry metadata by analysing the input text corpus, the input inquiry metadata comprising one or more input text objects generated from the input text corpus of the input inquiry,
determine, with the input context generator, an input location of the input user device on the information location map,
determine, with a map locator, one or more points of interest on the information location map within a first predetermined distance from the input location of the input user device based on the one or more input text objects of the input inquiry metadata and the information location map; and
carry out process B)
detect, with an output context generator output user devices within a predetermined output distance from the one or more points of interest on the information location map,
share the input inquiry with the detected output user devices within the predetermined output distance from the one or more points of interest,
receive one or more responses from the detected output user devices within the predetermined output distance from the one or more points of interest, and
generate a response notification based on the one or more responses received from the detected output user devices and provide the response notification to the input user device.

23. The information system according to claim 22, wherein the input context generator comprises an input location detector configured to determine the input location of the input user device by one, more, or combination of the following:
determine input user device GPS location;
determine input user device IP address location;
determine input user device cellular network location;
determine the location of the input user device by deriving the location from the input inquiry or the input inquiry metadata.

24. The information system according to claim 22, wherein the map locator is configured to associate the input user device to the input location on the information location map.

25. The information system according to claim 22, wherein the input context generator comprises an input context detector configured to generate primary input inquiry metadata, the primary input inquiry metadata comprising one or more primary input text objects generated from the input text corpus of the input inquiry, the input context detector is configured to carry out one or more of the following:
detect the language of the input text corpus,
divide the input text corpus to n-grams, the one or more primary input text objects comprising the n-grams, and
identify keywords in the input text corpus, the one or more primary input text objects comprising the keywords.

26. The information system according to claim 25, wherein the input context generator comprises an input context enhancer configured to generate secondary input inquiry metadata, the secondary input inquiry metadata comprising one or more secondary input text objects generated from the one or more primary input text objects of the primary inquiry metadata, the input context enhancer is configured to carry out one or more of the following:
determine synonyms for the n-grams in the primary input inquiry metadata, and
determine synonyms for the keywords in the primary input inquiry metadata.

27. The information system according to claim 22, wherein the input inquiry comprises image data or video data, and the information system is upon receiving the input inquiry configured to:
generate an image text description from the image data or video data and incorporate the image text description generated from the image data or video data to the input text corpus; or
carry out optical character recognition to the image data or video data, generate an image text description of the image data or video data based on the optical character recognition, and incorporate the image text description generated from the image data or video data to the input text corpus, or
generate an image text description from the image data or video data and incorporate the image text description generated from the image data or video data to the input text corpus, and carry out optical character recognition to the image data or video data, generate an image text description of the image data or video data based on the optical character recognition, and incorporate the image text description generated from the image data or video data to the input text corpus.

28. The information system according to claim 22, wherein the input inquiry comprises audio data, and the information system is upon receiving the input inquiry configured to:
generate an audio text description from the audio data and incorporate the audio text description generated from the audio data to the input text corpus; or
carry out speech recognition to the audio data and generate an audio text description based on the speech recognition and incorporate the audio text description to the input text corpus; or
generate an audio text description from the audio data and incorporate the audio text description generated from the audio data to the input text corpus, and carry out speech recognition to the audio data and generate an audio text description based on the speech recognition and incorporate the audio text description to the input text corpus.

29. The information system according to claim 22, wherein the information location map comprises the area map and information objects associated with area locations on the information location map, the map locator being configured to determine the one or more points of interest:
compare the one or more input text objects of the input inquiry metadata with the information objects of the information location map, and
determine the one or more points of interest on the information location map based on the comparing, the one or more points of interest being associated with an information object on the information location map matching with an input text object of the input inquiry metadata; or
compare the one or more primary input text objects of the primary input inquiry metadata with the information objects of the information location map,
compare the one or more secondary input text objects of the secondary input inquiry metadata with the information objects of the information location map, and
determine the one or more points of interest based on the comparing, the one or more points of interest being associated to an information object matching with a primary input text object in the primary input inquiry metadata, or with a secondary input text object in the secondary input inquiry metadata, or with a primary input text object in the primary input inquiry metadata and with a secondary input text object in the secondary input inquiry metadata.

30. The information system according to claim 22, wherein the information system comprises a known places database, the known places database maintaining information objects, the information objects having associated area location information, map locator is configured to determine the one or more points of interest on the information location map by:
comparing the one or more input text objects of the input inquiry metadata with the information objects of the known places database,
determining a matching information object in the known places database based on comparing the one or more input text objects of the input inquiry metadata with the information objects of the known places database, and
determining the one or more points of interest on the information location map based on the location information associated with the matching information object; or
comparing the one or more primary input text objects of the primary input inquiry metadata with the information objects of the known places database,
comparing the one or more secondary input text objects of the secondary input inquiry metadata with the information objects of the known places database,
determining a matching information object in the known places database based on comparing the one or more primary input text objects of the primary input inquiry metadata and the one or more secondary input text objects of the secondary input inquiry metadata with the information objects of the known places database, and
determining the one or more points of interest on the information location map based on the location information associated with the matching information object.

31. The information system according to claim 22, wherein the output context generator comprises an output location detector configured to determine location of the output user devices by one, more, or combination of the following:
determine output user device GPS location;
determine output user device IP address location;
determine output user device cellular network location; and
determine the location of the output user device by deriving the location from the received response.

32. The information system according to claim 22, wherein the one or more responses comprising output text corpus, and the output context generator is configured to generate output response metadata for each of the received one or more responses by analysing the output text corpus of each of the received one or more responses, the output response metadata comprising one or more output text objects generated from the output text corpus of the one or more responses, respectively.

33. The information system according to claim 22, wherein the information system comprises a response collector, the response collector being configured to:
maintain a pre-determined response score threshold,
receive one or more candidate responses from the output user devices,
determine a response score for each of one or more candidate responses by comparing the output text corpus of each of the one or more candidate responses with the input text corpus of the input inquiry, or the output text corpus and output response metadata of each of the one or more candidate responses with the input text corpus and input inquiry metadata of the input inquiry,
compare the response score of each of the candidate responses with the pre-determined response score threshold, and based on the comparing the response collector is configured to:
discard the candidate response if the response score of the candidate response is below the pre-determined response score threshold, or
store the candidate response as a qualified response if the response score of the candidate response is above the pre-determined response score threshold.

34. The information system according to claim 22, wherein the information location map comprises the area map and information objects associated with area locations on the information location map, the map locator being configured to determine a response location on the information location map:
compare the one or more output text objects of the output response metadata with the information objects of the information location map, and
determine the response location on the information location map based on the comparing, the response location being associated to an information object on the information location map matching with an output text object of the output response metadata.

35. The information system according to claim 22, wherein characterized in that the map locator is configured to determine a response location on the information location map:
compare the one or more output text objects of the output response inquiry metadata with the information objects of the known places database,
determine a matching information object in the known places database based on comparing the one or more output text objects of the output response metadata with the information objects of the known places database, and
determine the output location on the information location map based on the location information associated with the matching information object.

36. The information system according to claim 22, wherein the information system comprises the response collector, the response collector being configured to:
maintain a first pre-determined response number threshold,
keep tally of received responses or qualified responses, and
if the number of received responses or qualified responses is above the first pre-determined response number threshold, generate the response notification based on the received responses or qualified responses and provide the response notification to the input user device, or
if the number of received responses or qualified responses is below the first pre-determined response number threshold, the information system is configured to:
determine, with the map locator, subsequent one or more points of interest on the information location map within the predetermined distance from the previous point of interest based on the one or more input text objects of the input inquiry metadata and the information location map, and
carry out process B)
detect, with the output context generator output user devices within the predetermined output distance from the subsequent one or more points of interest,
share the input inquiry with the detected output user devices within the predetermined output distance from the subsequent one or more points of interest,
receive one or more responses from the output user devices within the predetermined output distance from the subsequent one or more points of interest,
generate the response notification based on the one or more responses received from the output user devices, and
provide the response notification to the input user device.

37. The information system according to claim 22, wherein the information system comprises the response collector, the response collector being configured to:
to detect the cluster of response locations on the information map by comparing the response locations of the received responses or qualified responses, and
if a cluster of response locations is detected on the information location map, generating the response notification based on the responses associated with the cluster and providing the response notification to the input user device, or
if a cluster of response locations is not detected on the information location map, the information system is configured to:
determine, with the map locator, a subsequent one or more points of interest on the information location map within the predetermined distance from the previous one or more points of interest based on the one or more input text objects of the input inquiry metadata and the information location map, and
carry out process B)
detect, with the output context generator, output user devices within the predetermined output distance from the subsequent one or more points of interest,
share the input inquiry with the detected output user devices within the predetermined output distance from the subsequent one or more points of interest,
receive one or more responses from the output user devices within the predetermined output distance from the subsequent one or more points of interest,
generate a response notification based on the one or more responses received from the output user devices, and
provide the response notification to the input user device.

38. The information system according to claim 22, wherein the information system comprises a response aggregator, the response aggregator being configured to:
aggregate the one or more received responses into a single response,
determine an aggregated response location for the single response based on the response locations of the received responses, and
associate the aggregated response location with the single response; or
aggregate the qualified responses into a single response,
determine an aggregated response location for the single response based on the response locations of the qualified responses,
associate the aggregated response location with the single response; or
aggregate the one or more responses associated with the cluster into a single response,
determine an aggregated response location for the single response based on the response locations of the responses associated with the cluster, and
associate the aggregated response location with the single response.

39. A method for question answering, information retrieval, and location discovery, the method being carried out with an information system comprising one or more processors and a memory storing instructions for execution by the one or more processors, wherein the method comprises:
providing an information location map, the information location map comprising an area map;
carrying out process A) comprising:
receiving an input inquiry from an input user device, the input inquiry comprising input text corpus,
generating, with an input context generator, input inquiry metadata by analysing the input text corpus, the input inquiry metadata comprising one or more input text objects generated from the input text corpus of the input inquiry,
determining, with the input context generator, an input location of the input user device on the information location map,
determining, with a map locator, one or more points of interest on the information location map within a first predetermined distance from the input location of the input user device based on the one or more input text objects of the input inquiry metadata and the information location map; and
carrying out process B)
detecting, with an output context generator output user devices within a predetermined output distance from the one or more points of interest on the information location map,
sharing the input inquiry with the detected output user devices within the predetermined output distance from the one or more points of interest,
receiving one or more responses from the detected output user devices within the predetermined output distance from the one or more points of interest, and
generating a response notification based on the one or more responses received from the detected output user devices and provide the response notification to the input user device.

40. The computer program product wherein the computer program product is configured to carry out the method according to claim 39.
